(19) United States
(12) Patent Application Publication
(10) Pub. No.: US 2015/0062378 A1
(43) Pub. Date: Mar. 5, 2015

(54) SOLID-STATE IMAGING DEVICE AND INFORMATION PROCESSING CIRCUIT

(71) Applicant: Kabushiki Kaisha Toshiba, Minato-ku (JP)

(72) Inventor: Naoto WATANABE, Yokohama-shi (JP)

(73) Assignee: Kabushiki Kaisha Toshiba, Minato-ku (JP)

(21) Appl. No.: 14/200,690

(22) Filed: Mar. 7, 2014

(30) Foreign Application Priority Data
Sep. 2, 2013 (JP) 2013-181695

(51) Int. Cl. H04N 5/232

(52) U.S. Cl. CPC H04N 5/23229
USPC 348/231.99

(57) ABSTRACT

According to one embodiment, a solid-state imaging device includes a storage unit configured to temporarily store digital data received via an encoder and to output the digital data via a decoder, and a calculation unit configured to calculate the digital data received from the storage unit via the decoder and to output the resultant data. The encoder encodes the digital data so as to subtract a predetermined level+1 level from data included in the digital data and having a luminance level higher than the predetermined level. The decoder decodes the digital data so as to add the predetermined level+1 level to data included in the digital data, having a luminance level, and resulting from a subtraction of the predetermined level+1 level carried out by the encoder.

### CROSS-REFERENCE TO RELATED APPLICATIONS

This application is based upon and claims the benefit of priority from prior Japanese Patent Application No. 2013-181695, filed Sep. 2, 2013, the entire contents of which are incorporated herein by reference.

### FIELD

The present embodiment relates to a solid-state imaging device and an information processing circuit.

### BACKGROUND

Digital cameras, video cameras, and the like use a solid-state imaging device in order to pick up an image of a subject. The solid-state imaging device may disadvantageously be subjected to streaking (high-luminance horizontal streak noise) that occurs in a horizontal direction in image data resulting from an A/D (Analog/Digital) conversion.

A cause of streaking is a fluctuation of a digital power supply (a circuit carrying out digital processing) for a logic unit or the like. The fluctuation of the digital power supply affects an analog power supply. Thus, a VREF (reference voltage) waveform of the analog power supply fluctuates to cause streaking.

Furthermore, the fluctuation of the digital power supply depends on a difference in IR drop resulting from a difference in the power consumption of a signal processing circuit between a high luminance (saturated) area and the other area (low luminance area) in an image. Thus, the high luminance (saturated) area may overlap a sensitive portion of the VREF waveform (for example, an inclined portion of the VREF waveform) to cause streaking.

A saturated pixel resulting from an A/D conversion and output by a sensor core (ADC) has saturation unevenness. Thus, in Comparative Example 1, the sensor core carries out an A/D conversion on the saturated pixel at a resolution finer (for example, 11 bits) than a desired bit width (for example, 10 bits). Subsequently, at the beginning of digital processing steps, saturation clipping is carried out on the saturated pixel, which is then set to a fixed value (for example, 10 bits). Hence, the correct luminance level is obtained. Furthermore, fixing the saturated pixel to the desired bit width enables a reduction in the scale of a circuit for digital processing and in total power consumption.

However, at this time, the saturation clipping fixes the data in the high luminance (saturated) area to reduce the noise (unevenness) in the data, whereas noise remains in the data in the low luminance area. When the digital processing steps are carried out in this state, the power consumed during the digital processing (calculations) in the high luminance area is lower than the power consumed during the digital processing in the low luminance area. As a result, the difference in power consumption causes streaking as described above.

### BRIEF DESCRIPTION OF THE DRAWINGS

FIG. 1 is a block diagram showing a general configuration of a digital camera including a solid-state imaging device according to the present embodiment;

FIG. 2 is a block diagram showing a general configuration of the solid-state imaging device according to the present embodiment;

FIG. 3 is a block diagram showing a general configuration of a signal processing circuit according to the present embodiment;

FIG. 4 is a diagram illustrating a saturation clipping operation performed by a clip circuit;

FIG. 5 is a diagram illustrating an example of an encode operation performed by an encoder and a decode operation performed by a decoder;

FIG. 6 is a diagram illustrating another example of an encode operation performed by the encoder and a decode operation performed by the decoder;

FIG. 7 is a block diagram showing an example of a calculation unit shown in FIG. 3;

FIG. 8 is a flowchart showing operations of the solid-state imaging device according to the present embodiment;

FIG. 9 is a flowchart showing operations performed by a solid-state imaging device according to Comparative Example 1; and

FIG. 10 is a flowchart showing operations performed by a solid-state imaging device according to Comparative Example 2.

### DETAILED DESCRIPTION

In general, according to one embodiment, a solid-state imaging device includes a pixel array comprising pixels and configured to generate a signal charge depending on an amount of light incident on each of the pixels, an analog digital conversion unit configured to covert the signal charge into digital data and to output the digital data, a storage unit configured to temporarily store the digital data received from the analog digital conversion unit via an encoder and to output the digital data via a decoder, and a calculation unit configured to calculate the digital data received from the storage unit via the decoder and to output the digital data. The encoder encodes the digital data so as to subtract a predetermined level+1 level from pixels included in the digital data and having a luminance level higher than the predetermined level. The decoder decodes the digital data so as to add the predetermined level+1 level to pixels included in the digital data, having a luminance level, and resulting from a subtraction of the predetermined level+1 level carried out by the encoder.

The present embodiment will be described below with reference to the drawings. In the drawings, the same components are denoted by the same reference numerals. Furthermore, a duplicate description will be provided as necessary.

### Embodiment

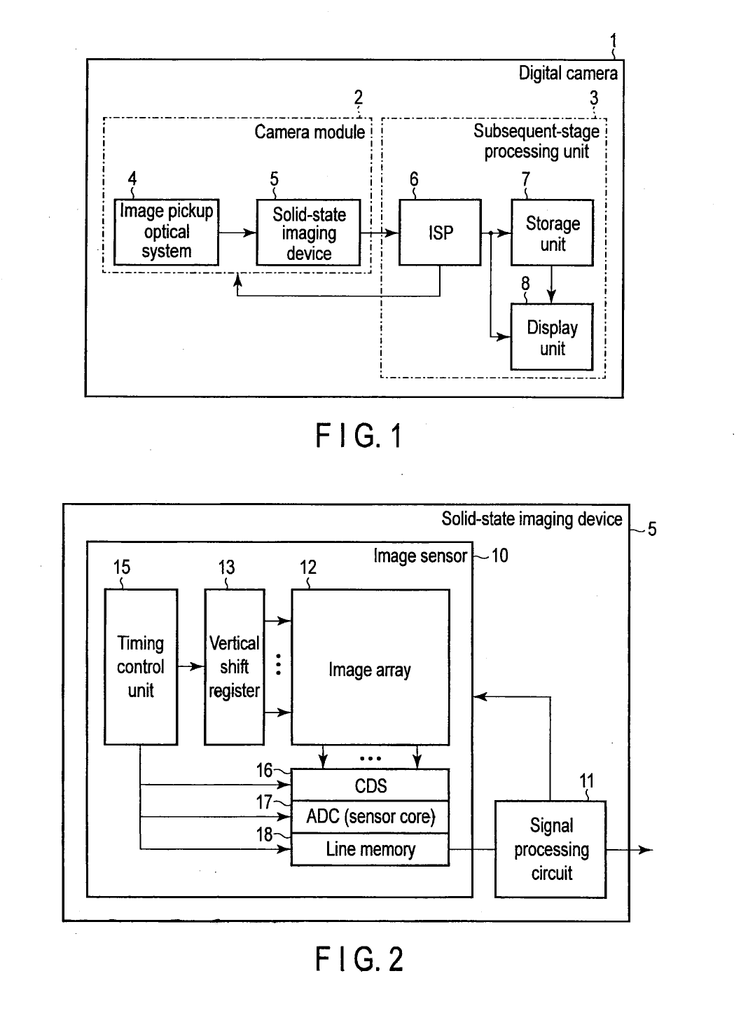

With reference to FIG. 1 to FIG. 10, a solid-state imaging device according to the present embodiment will be described.

According to the present embodiment, a circuit (signal processing circuit 11) that carries out digital processing comprises a storage unit such as SRAM 24 preceded by an encoder 23 (which provides an input to the storage unit) and followed by a decoder 25 (which receives an output from the storage unit). Processing for a desired bit width (for example, 10 bits) is carried out in SRAM 24, and processing for a bit width (for example, 11 bits) larger than the desired bit width is carried out in a calculation unit 22. Thus, possible streaking can be inhibited with an increase in the circuit scale of the signal processing circuit 11 suppressed. The present embodiment will be described below.

[Configuration]

With reference to FIG. 1 to FIG. 8, a configuration of the solid-state imaging device according to the present embodiment will be described.

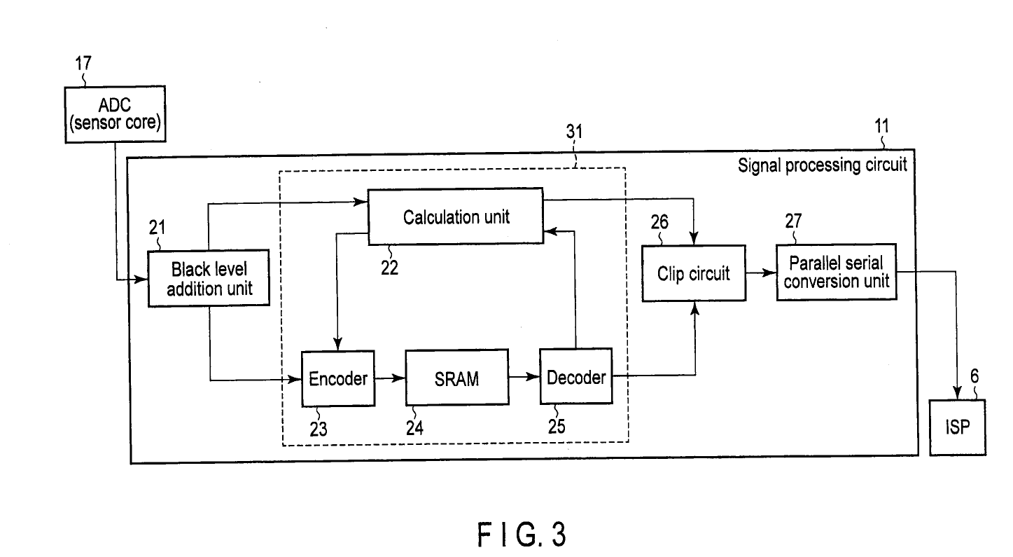

FIG. 1 is a block diagram showing a general configuration of a digital camera with the solid-state imaging device according to the present embodiment. FIG. 2 is a block diagram showing a general configuration of a solid-state imaging device according to the present embodiment.

As shown in FIG. 1, a digital camera 1 comprises a camera module 2 and a subsequent-stage processing unit 3. The camera module 2 comprises an image pickup optical system 4 and a solid-state imaging device 5. The subsequent-stage processing unit 3 comprises an ISP (Image Signal Processor) 6, a storage unit, and a display unit 8. The camera module 2 is applied to an electronic device, for example, a mobile terminal with a camera.

The image pickup optical system 4 captures light from a subject to form a subject image. The solid-state imaging device 5 performs an image pickup operation on the subject image. The ISP 6 carries out signal processing on an image signal resulting from the image pickup preformed by the solid-state imaging device 5. The storage unit 7 receives the image subjected to the signal processing by the ISP 6 for storage. The storage unit 7 outputs the image signal to the display unit 8 in accordance with a user's operation or the like. The display unit 8 displays an image in accordance with the image signal received from the ISP 6 or the storage unit 7. The display unit 8 is, for example, a liquid crystal display. Furthermore, data subjected to the signal processing by the ISP 6 is fed back into the camera module 2.

As shown in FIG. 2, the solid-state imaging device 5 comprises a signal processing circuit 11 and an image sensor 10 that is an image pickup element. The image sensor 10 is, for example, a CMOS image sensor. The image sensor 10 may be a CCD instead of the CMOS image sensor.

The image sensor 10 comprises a pixel array 12, a vertical shift register 13, a timing control unit 15, a CDS (correlated double sampling unit) 16, an ADC (analog digital conversion unit (sensor core)) 17, and a line memory 18. The pixel array 12 is provided in an image pickup area of the image sensor 10. The pixel array 12 comprises a plurality of pixels arranged in an array in a horizontal direction (row direction) and a vertical direction (column direction). Each of the pixels comprises a photo diode that is a photoelectric conversion element. The pixel array 12 generates signal charge according to the amount of light incident on each pixel. The generated signal charge is converted into digital data via the CDS/ADC, and the digital data is output to the signal processing circuit 11. The signal processing circuit 11 carries out, for example, lens shading correction, damage correction, and a noise reduction process. The data subjected to the signal processing is, for example, output to the outside of a chip and fed back into the image sensor 10.

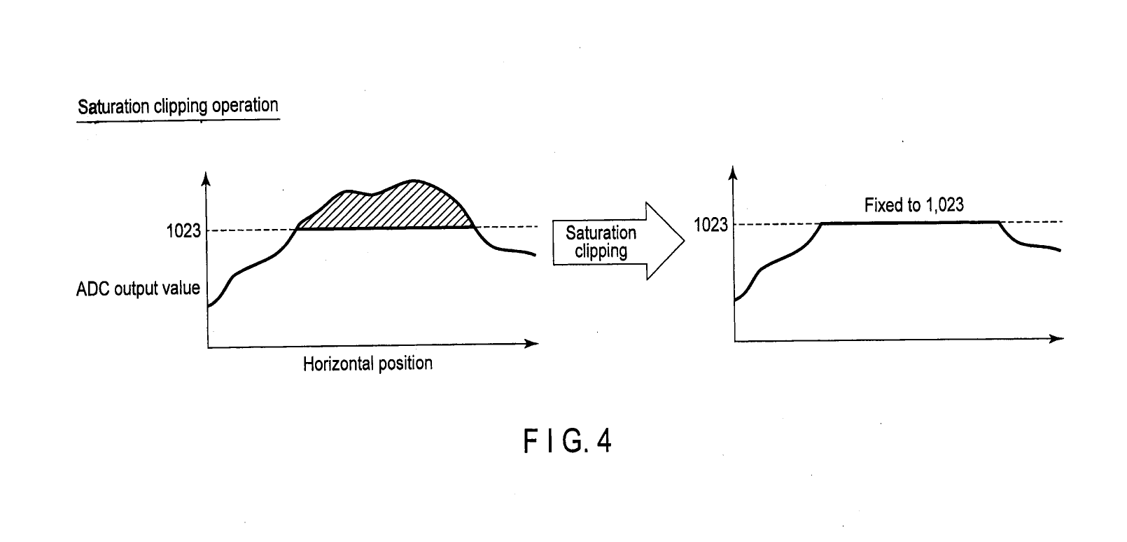

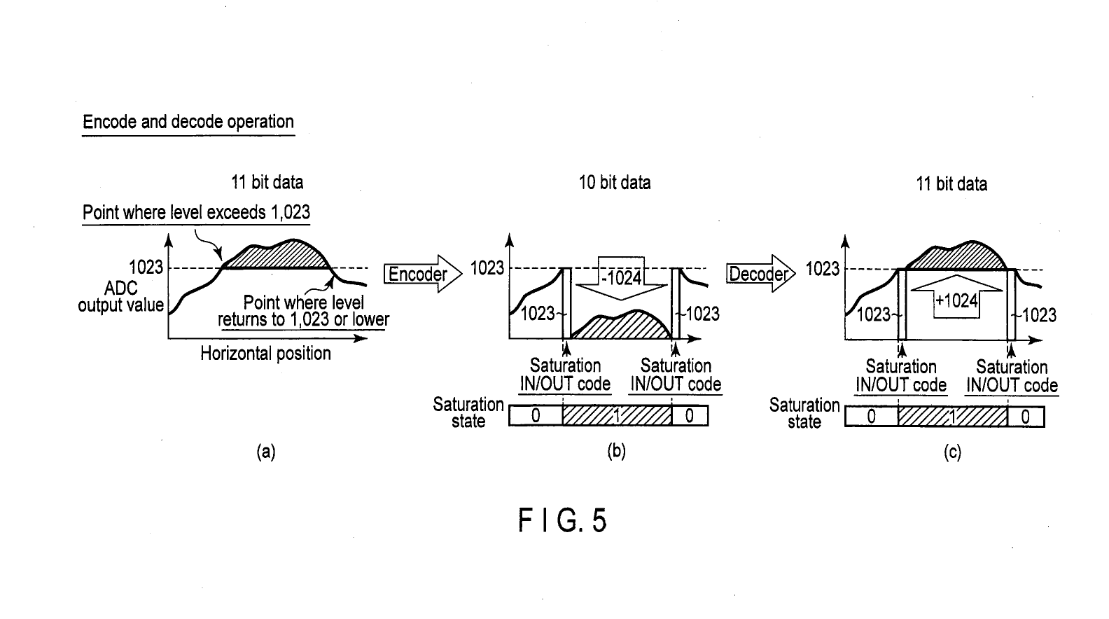

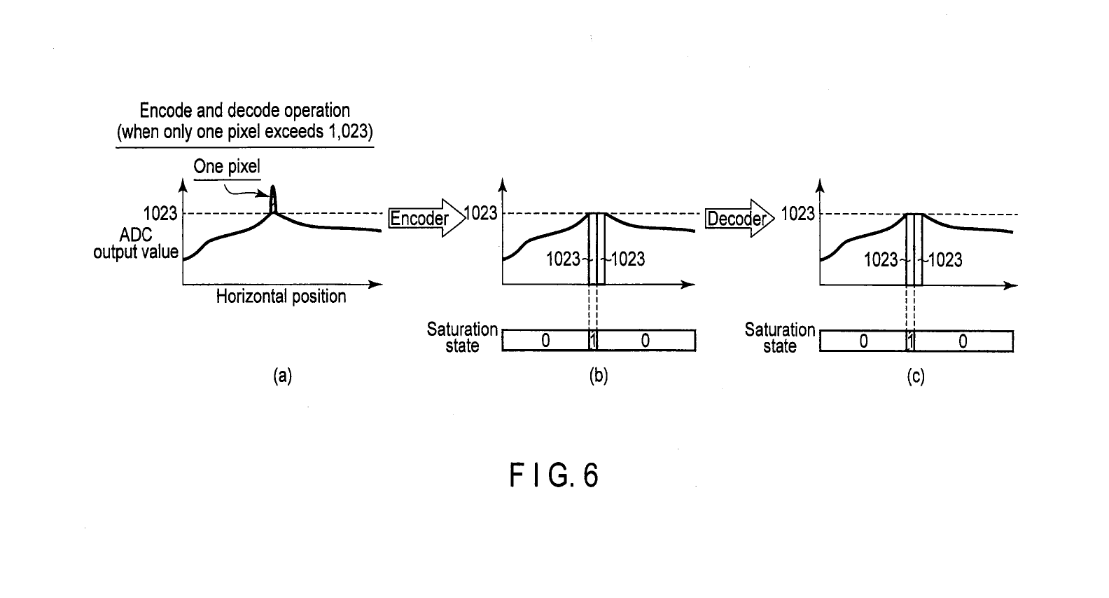

FIG. 3 is a block diagram showing a general configuration of the signal processing circuit according to the present embodiment. FIG. 4 is a diagram illustrating a saturation clipping operation performed by a clip circuit. FIG. 5 is a diagram illustrating an example of an encode operation performed by an encoder and a decode operation performed by a decoder. FIG. 6 is a diagram illustrating another example of an encode operation performed by the encoder and a decode operation performed by the decoder

As shown in FIG. 3, the signal processing circuit 11 is a circuit that processes digital data into which analog data (signal charge) is converted by the ADC 17. The signal processing circuit 11 outputs processed data to the ISP 6. The signal processing circuit 11 comprises a black level addition unit 21, a logical operation unit 31, a clip circuit 26, and a parallel serial conversion unit 27.

The black level addition unit 21 adds black level data to digital data (digital image signal) received from the ADC 17. The black level addition unit 21 then outputs the digital data with the black level data added thereto to the logical operation unit 31.

The logical operation unit 31 carries out various calculations on the digital data received from the black level addition unit 21. The various calculations are carried out by the calculation unit 22, described below, and the digital data is temporarily stored in the SRAM, described below, during the calculations. The logical operation unit 31 outputs the calculated digital data to the clip circuit 26. The logical operation circuit 31 will be described below in detail.

The clip circuit 26 carries out saturation clipping on the digital data received from the logical operation circuit 31. More specifically, as shown in FIG. 4, the clip circuit 26 fixes pixels (pixel data) with a luminance level of 10 bits (0 level to 1,023 level) or more to the 1,023 level. This allows any saturation unevenness in a saturated area (high luminance area) of the digital data to be eliminated. The clip circuit 26 outputs the digital data subjected to saturation clipping to the parallel serial conversion unit 27.

The parallel serial conversion unit 27 outputs the digital data received from the clip circuit 26 to the ISP 6. At this time, the parallel serial conversion unit 27 converts the digital data from a parallel input to a serial output or from a serial input to a parallel output. Furthermore, the parallel serial conversion unit 27 functions as an interface with the signal processing circuit 11 and the ISP 6.

The signal processing circuit 11 as described above is formed in the same chip. Furthermore, the ADC 17 and the signal processing circuit 11 may be formed in the same chip.

The logical operation circuit 31 according to the present embodiment will be described below in further detail.

The logical operation circuit 31 comprises a calculation unit 22, an encoder 23, SRAM 24 (FIFO SRAM), and a decoder 25.

The calculation unit 22 comprises various calculation circuits to carry out various calculations on digital data received from the black level addition unit 21 or the decoder 25. The calculation unit 22 outputs the calculated digital data to the encoder 23 or the clip circuit 26. That is, the calculation unit 22 outputs the calculated digital data to SRAM 24 via the encoder 23 for temporary storage.

At this time, the digital data input to the calculation unit 22 is, for example, 11 bit data. Thus, the calculation unit 22 carries out calculations for 11 bit processing. That is, the calculation unit 22 carries out calculations with possible saturation unevenness remaining in the high luminance area of the digital data. In other words, the calculation unit 22 carries out calculations with possible noise remaining in the high luminance area and low luminance area of the digital data. Thus, the calculation unit 22 enables a reduction in difference in power consumption between the calculation for the high luminance area of the digital data and the calculation for the low luminance area of the digital data. Therefore, streaking can be prevented from occurring in the processing carried out by the calculation unit 22. Furthermore, the calculation unit 22 carries out calculations for 11 bit processing and can thus achieve the calculations without degrading image quality.

The encoder 23 encodes digital data received from the black level addition unit 21 or the calculation unit 22. The encoder 23 outputs encoded digital data to SRAM 24. That is, the encoder 23 encodes digital data not having been input to SRAM 24 yet.

Now, an example will be described in which digital data is encoded as shown in (a) in FIG. 5. As shown in (a) and (b) in FIG. 5, the encoder 23 encodes the received 11 bit digital data to obtain 10 bit digital data.

More specifically, the encoder 23 encodes the digital data starting with the first pixel at a horizontal position in the digital data. At this time, the encoder 23 resets the saturation state of first pixel at the horizontal position to “0” (a corresponding flag is reset). In (a) in FIG. 5, the first pixel at the horizontal position is in a low luminance area. The encoder 23 then performs encoding in the low luminance area in order in the horizontal direction, and upon shifting from the low luminance area to the high luminance area, adds a saturation IN/OUT code to the first pixel (leading pixel) in the high luminance area (the point where the luminance level exceeds the predetermined level (1,023 level)). The saturation IN/OUT code is output as the 1,023 level. In response, the encoder 23 sets the saturation state of pixels with a luminance level exceeding the 1,023 level to “1” (the flag is set). Pixels having the 1,023 level at the time of inputting are considered to be pixels with the 1,022 level. The encoder 23 subtracts the predetermined level+1 level (1,024 level) from pixels with the saturation state set to “1” (pixels in the high luminance area). Subsequently, the encoder 23 further performs encoding in the high luminance area in order in the horizontal direction, and upon shifting from the high luminance area to the low luminance area, adds the saturation IN/OUT code to the first pixel (leading pixel) in the low luminance area (the point where the luminance level returns to the 1,023 level or lower). In response, the encoder 23 resets the saturation state of pixels with a luminance level equal to or lower than the 1,023 level to “0”.

As described above, the encoder 23 outputs pixels in the digital data which have a luminance level equal to or lower than the 1,023 level, directly to SRAM 24. The encoder 23 subtracts the 1,024 level from pixels with a luminance level exceeding the 1,023 level (pixels with the 1,024 level or higher) and outputs the result of the subtraction to SRAM 24. That is, the encoder 23 converts an 11 bit digital image signal into a 10 bit digital image signal and outputs the 10 bit digital image signal.

SRAM 24 temporarily stores 10 bit digital data received from the encoder 23. SRAM 24 outputs the digital data to the decoder 25. That is, SRAM 24 outputs the digital data to the calculation unit 22 or the clip circuit 26 via the decoder 25.

To store 10 bit digital data, SRAM 24 may have a capacity of 10 bits. Furthermore, instead of SRAM 24, DRAM, MRAM, or the like may be used. Furthermore, instead of the storage area such as SRAM 24, a simple data path involving no calculation may be preceded by the encoder 23 and followed by the decoder 25.

The decoder 25 decodes digital data received by SRAM 24. The decoder 25 outputs the decoded digital data to the calculation unit 22 or the clip circuit 26. That is, the decoder 25 decodes the digital data output by SRAM 24.

In this case, an example will be described in which digital data is decoded as shown in (b) in FIG. 5. As shown in (b) and (c) in FIG. 5, the decoder 25 decodes received 10 bit digital data into 11 bit digital data.

More specifically, the decoder 25 decodes the digital data starting with the first pixel at the horizontal position in the digital data. At this time, the decoder 25 resets the saturation state of the first pixel at the horizontal position to “0”. In (b) in FIG. 5, the first pixel at the horizontal position is in the low luminance area. The decoder 25 then performs decoding in the low luminance area in order in the horizontal direction, and upon shifting from the low luminance area to the high luminance area, detects the saturation IN/OUT code added by the encoder 23 to the first pixel in the high luminance area (the point where the luminance level exceeds the 1,023 level). The saturation IN/OUT code is output so as to indicate that the luminance level is the 1,023 level. In response, the decoder 25 switches the saturation state to the other value. That is, the decoder 25 switches the saturation state from “0” to “1”. The decoder 25 adds the 1,024 level to pixels with the saturation state set to “1” (pixels in the high luminance area). Subsequently, the decoder 25 further performs decoding in the high luminance area in order in the horizontal direction, and upon shifting from the high luminance area to the low luminance area, detects the saturation IN/OUT code added by the encoder 23 to the first pixel in the low luminance area (the point where the luminance level returns to the 1,023 level or lower). In response, the decoder 25 switches the saturation state to the other value. That is, the decoder 25 switches the saturation state from “1” to “0”. Pixels with the 1,023 level are output without any change.

As described above, the decoder 25 outputs pixels in the digital data which have not been encoded by the encoder 23, directly to SRAM 24. The decoder 25 adds the 1,024 level to pixels encoded by the encoder 23 and outputs the result of the addition to SRAM 24. That is, the decoder 24 converts 10 bit digital data resulting from encoding carried out by the encoder 23 back into the original 11 bit digital data, and outputs the 11 bit digital data to the calculation unit 22 or the clip circuit 26.

The encoder 23 and the decoder 25 cause an error between the luminance level obtained before encoding and the luminance level obtained after decoding, at a pixel near the boundary between the low luminance area and the high luminance area (the pixel with the saturation IN/OUT code added thereto). However, the error is negligible and is treated as, for example, damage to the image.

Now, an example will be described in which a digital image signal is encoded as shown in (a) in FIG. 6. In the other illustrated examples, only the luminance level of one pixel exceeds the 1,023 level.

More specifically, as shown in (a) and (b) in FIG. 6, the encoder 23 encodes the digital data starting with the first pixel at the horizontal position in the digital data. At this time, the encoder 23 resets the saturation state of a first pixel at the horizontal position to “0”. In (a) in FIG. 6, the first pixel at the horizontal position is in the low luminance area. The encoder 23 then performs encoding in the low luminance area in order in the horizontal direction, and upon shifting from the low luminance area to the high luminance area, adds the saturation IN/OUT code to the first pixel in the high luminance area (the point where the luminance level exceeds the 1,023 level). The saturation IN/OUT code is output as the 1,023 level. In response, the encoder 23 sets the saturation state of a pixel with a luminance level exceeding the 1,023 level to “1”. In (a) in FIG. 6, at the next pixel (adjacent pixel), the high luminance area returns to the low luminance area (the luminance level returns to the 1,023 level or lower). Thus, the encoder 23 adds the saturation IN/OUT code to the next pixel. The saturation IN/OUT code is output as the 1,023 level. In response, the encoder 23 resets the saturation state of the pixel with a luminance level equal to or lower than the 1,023 level to “0”.

Thus, when only the luminance level of one pixel in the digital data exceeds the 1,023 level, the encoder 23 adds the saturation IN/OUT code to the one pixel and the next pixel (adjacent pixel). In other words, the one pixel and the next pixel have a luminance level fixed to the 1,023 level.

Now, an example will be described in which a digital image signal is encoded as shown in (b) in FIG. 6.

More specifically, as shown in (a) and (b) in FIG. 6, the decoder 25 decodes the digital data starting with the first pixel at the horizontal position in the digital data. At this time, the decoder 25 resets the saturation state of a first pixel at the horizontal position to “0”. In (b) in FIG. 6, the first pixel at the horizontal position is in the low luminance area. The decoder 25 then, upon shifting from the low luminance area to the high luminance area, detects the saturation IN/OUT code added by the encoder 23 to the first pixel in the high luminance area (the point where the luminance level exceeds the 1,023 level). The saturation IN/OUT code is output so as to indicate that the luminance level is the 1,023 level. In response, the decoder 25 switches the saturation state to the other value. That is, the saturation state switches from “0” to “1”. The decoder 25 then, upon shifting from the high luminance area to the low luminance area, detects the saturation IN/OUT code added by the encoder 23 to the next pixel in the low luminance area (the point where the luminance level returns to the 1,023 level). The saturation IN/OUT code is output so as to indicate that the luminance level is the 1,023 level. In response, the decoder 25 switches the saturation state to the other value. That is, the saturation state switches from “1” to “0”.

As described above, when only the luminance level of one pixel in the digital data exceeds the 1,023 level, the decoder 25 outputs one pixel and the next pixel (adjacent pixel) with the saturation IN/OUT code added thereto by the encoder 23, to SRAM 24 as pixels with the 1,023 level. In other words, the luminance level of the one pixel and the next pixel is fixed to the 1,023 level before the pixels are output. The pixels are treated as, for example, damage to the image.

In the above-described encoding and decoding, only the luminance level of one pixel in the digital image signal exceeds the 1,023 level or higher. However, similar operations are performed when only the luminance level of one pixel returns to the 1,023 level or lower.

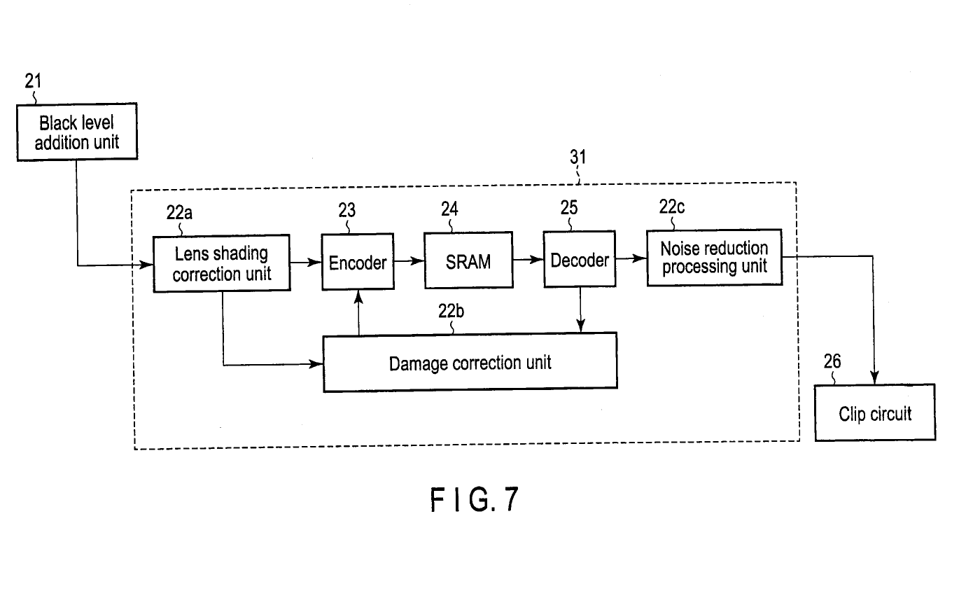

FIG. 7 is a block diagram showing an example of the calculation unit shown in FIG. 3. In FIG. 7, the calculation unit 22 comprises a lens shading correction unit 22a, a damage correction unit 22b, and a noise reduction process unit 22c.

The lens shading correction unit 22a carries out lens shading correction on digital data received from the black level addition unit 21. The lens shading correction unit 22a outputs the digital data subjected to the lens shading correction to the damage correction unit 22b and to SRAM 24 via the encoder 23.

The damage correction unit 22b carries out damage correction on the digital data using the digital data received from the lens shading correction unit 22a and the digital data temporarily stored in SRAM 24 and received from SRAM 24 via the decoder 25. The damage correction unit 22b then outputs the digital data subjected to the damage correction to SRAM 24 via the encoder 23.

The noise reduction process unit 22c carries out a noise reduction process on the digital data temporarily stored in SRAM 24 and received from SRAM 24 via the decoder 25. The noise reduction process unit 22c then outputs the digital data subjected to the noise reduction process to the clip circuit 26.

The lens shading coercion unit 22a, the damage correction unit 22b, and the noise reduction process unit 22c carry out the respective calculations based on 11 bit processing. On the other hand, since SRAM 24 is preceded by the encoder 23 and followed by the decoder 25, the digital data is temporarily stored based on 10 bit processing.

When the calculation process (for example, the noise reduction process) need not be carried out on the digital data temporarily stored in SRAM 24, the decoder 25 need not convert 10 bit data into 11 bit data. In this case, the decoder 25 may perform an operation similar to the operation of the clip circuit 26, that is, fix the luminance level of pixels with 10 bits (0 level to 1,023 level) or more to the 1,023 level. Furthermore, the decoder 25 may convert 10 bit data into 11 bit data and then process the 11 bit data without carrying out saturation clipping.

[Operation]

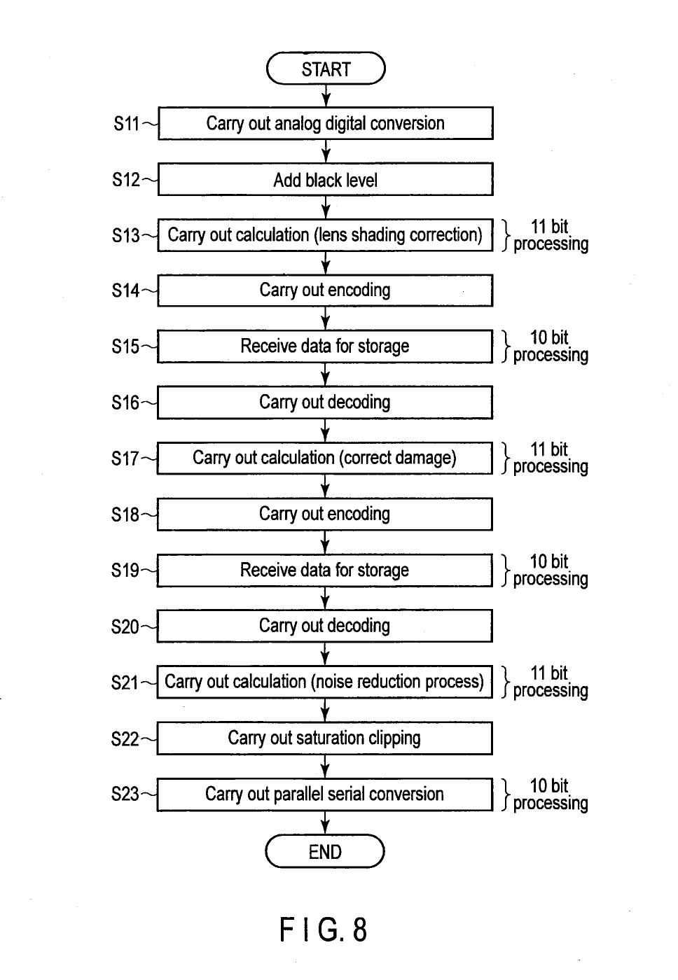

Operations of the solid-state imaging device according to the present embodiment will be described with reference to FIG. 8.

FIG. 8 is a flowchart showing the operations of the solid-state imaging device according to the present embodiment.

As shown in FIG. 8, first, the ADC 17 converts analog data into digital data in step S11.

Then, in step S12, the black level addition unit 21 adds black level data to the digital data resulting from the conversion.

In step S13, the lens shading correction unit 22a carries out lens shading correction on the digital data with the black level data added thereto. The lens shading correction is based on 11 bit processing.

Then, in step S14, the encoder 23 encodes the digital data subjected to the lens shading correction. This converts the 11 bit digital data into 10 bit digital data.

In step S15, SRAM 24 receives the encoded digital data for temporary storage. The data storage is based on 10 bit processing.

In step S16, the decoder 25 decodes the temporarily stored digital data. Thus, the 10 bit digital data is converted into 11 bit digital data.

In step S17, the damage correction unit 22b carries out damage correction on the digital data using the decoded digital data and the digital data subjected to the lens shading correction. This damage correction is based on 11 bit processing.

In step S18, the encoder 23 encodes the digital data subjected to the damage correction. Thus, the 11 bit digital data is converted into 10 bit digital data.

In step S19, SRAM 24 receives the encoded digital data for temporary storage. The data storage is based on 10 bit processing.

In step S20, the decoder 25 decodes the temporarily stored digital data. Thus, the 10 bit digital data is converted into 11 bit digital data.

In step S21, the noise reduction process unit 22c carries out a noise reduction process on the decoded digital data. The noise reduction process is based on 11 bit processing.

In step S22, the clip circuit 26 carries out saturation clipping on the digital data subjected to the noise reduction process. Thus, pixels with 10 bits (a luminance level of 0 to 1,023) or more are fixed to the 1,023 level.

Subsequently, in step S23, the parallel serial conversion unit 27 converts the digital data subjected to the saturation clipping from a parallel input to a serial output or from a serial input to a parallel output. This parallel serial conversion is based on 10 bit processing in which pixels with 10 bits (0 level to 1,023 level) or more are fixed to the 1,023 level.

As described above, the operations of the solid-state imaging device according to the present embodiment end.

[Effects]

According to the present embodiment, the circuit (signal processing circuit 11) that carries out digital processing comprises the SRAM 24, which temporarily stores data and which is preceded by the encoder 23 (which provides an input to the storage unit) and followed by the decoder 25 (which receives an output from the storage unit). This allows the following effects to be exerted.

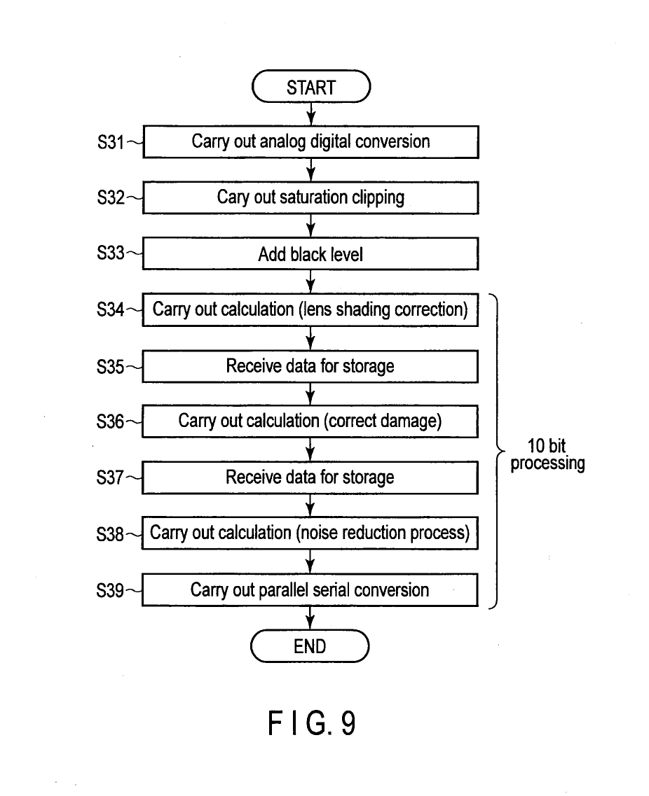

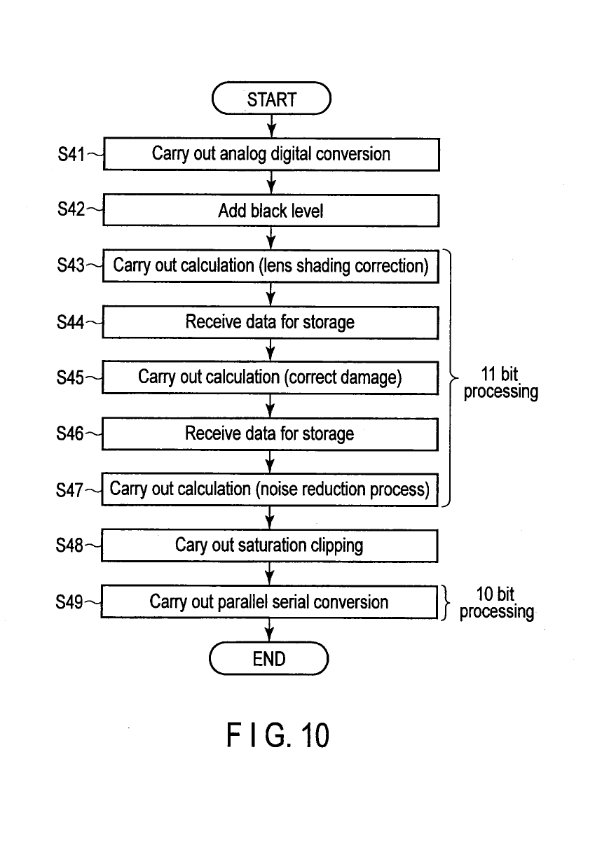

FIG. 9 is a flowchart showing operations of a solid-state imaging device according to Comparative Example 1. FIG. 10 is a flowchart showing operations of a solid-state imaging device according to Comparative Example 2.

In Comparative Example 1, saturation clipping is carried out on digital data immediately after an analog digital conversion. Comparative Example 1 will be specifically described below.

As shown in FIG. 9, first, the ADC 17 converts analog data into digital data in step S31. Then, in step S32, the clip circuit carries out saturation clipping on the digital data. Thus, pixels with 10 bits (0 level to 1,023 level) or more are fixed to the 1,023 level. Then, in step S33, the black level addition unit adds black level data to the digital data. In step S34, the lens shading correction unit carries out lens shading correction on the digital data. In step S35, the SRAM receives the digital data for temporary storage. In step S36, the damage correction unit carries out damage correction on the digital data. In step S37, the SRAM receives the digital data for temporary storage. In step S38, the noise reduction process unit carries out a noise reduction process on the decoded digital data. Subsequently, in step S39, the parallel serial conversion unit converts the digital data from a parallel input to a serial output or from a serial input to a parallel output.

In Comparative Example 1, the calculations of the digital data (lens shading correction, damage correction, and noise reduction process) and the data storage are based on the 10 bit processing in which pixels with a luminance level of 10 bits (0 level to 1,023 level) or more are fixed to the 1,023 level. In this case, the saturation clipping fixes the data in the pixels with a luminance level of 10 bits or more (high luminance area) to reduce noise. On the other hand, noise remains in the data in pixels with a luminance level of 10 bits or less. This results in a difference in power consumption between the digital processing in the high luminance area and the digital processing in the low luminance area. Consequently, streaking may occur. Furthermore, since the pixels with a luminance level of 10 bits or more are fixed to the 1,023 level, the image is degraded in the high luminance area.

On the other hand, in Comparative Example 2, after each of the calculations is carried out on the digital data, the digital data is subjected to saturation clipping. Comparative Example 2 will be specifically described below.

As shown in FIG. 10, first, the ADC 17 converts analog data into digital data in step S41. Then, in step S42, the black level addition unit adds black level data to the digital data. In step S43, the lens shading correction unit carries out lens shading correction on the digital data. In step S44, the SRAM receives the digital data for temporary storage. In step S45, the damage correction unit carries out damage correction on the digital data. In step S46, the SRAM receives the digital data for temporary storage. In step S47, the noise reduction process unit carries out a noise reduction process on the decoded digital data. In step S48, the clip circuit carries out saturation clipping on the digital data. Thus, pixels with a luminance level of 10 bits (0 level to 1,023 level) or more are fixed to the 1,023 level. Subsequently, in step S49, the parallel serial conversion unit converts the digital data from a parallel input to a serial output or from a serial input to a parallel output.

In Comparative Example 2, the calculations of the digital data (lens shading correction, damage correction, and noise reduction process) and the data storage are based on 11 bit processing. In this case, the calculation unit 22, which carries out the calculations, and SRAM 24, which stores data, need to have a circuit scale sufficient to be able to execute the 11 bit processing. That is, the scale of the circuit for digital processing is increased.

In contrast, in the circuit (signal processing circuit 11) that carries out digital processing, SRAM 24 is preceded by the encoder 23 and followed by the decoder 25 according to the present embodiment. The use of the encoder 23 and the decoder 25 allows 10 bit processing to be carried out in SRAM 24, while allowing 11 bit processing to be carried out in the calculation unit 22. In other words, the encoded 10 bit processing is carried out in SRAM 24, for which neither possible streaking nor image degradation need to be taken into account. The decoded 11 bit processing is carried out in the calculation unit 22, for which possible streaking and image degradation need to be taken into account. This allows suppression of at least an increase in the circuit scale of SRAM 24. That is, in the signal processing circuit 11, possible streaking is inhibited with an increase in circuit scale for digital processing maximally suppressed. Furthermore, since the calculations are based on the 11 bit processing, image degradation can be suppressed.

While certain embodiments have been described, these embodiments have been presented by way of example only, and are not intended to limit the scope of the inventions. Indeed, the novel embodiments described herein may be embodied in a variety of other forms; furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array comprising pixels and configured to generate a signal charge depending on an amount of light incident on each of the pixels;
an analog digital conversion unit configured to covert the signal charge into digital data and to output the digital data;
a storage unit configured to temporarily store the digital data received from the analog digital conversion unit via an encoder and to output the digital data via a decoder; and
a calculation unit configured to calculate the digital data received from the storage unit via the decoder and to output the digital data,
wherein the encoder encodes the digital data so as to subtract a predetermined level+1 level from pixels included in the digital data and having a luminance level higher than the predetermined level, and
the decoder decodes the digital data so as to add the predetermined level+1 level to pixels included in the digital data and having a luminance level resulting from a subtraction of the predetermined level+1 level carried out by the encoder.

2. The device of claim 1, further comprising:
a clip circuit configured to fix, to the predetermined level, pixels which are included in the digital data received from the calculation unit and which have a luminance level equal to or higher than the predetermined level.

3. The device of claim 1, wherein the encoder adds a first saturation IN/OUT code to a first pixel included in the digital data and having a luminance level higher than the predetermined level and sets a flag, and the encoder adds a second saturation IN/OUT code to a first pixel included in the digital data and having a luminance level equal to or lower than the predetermined level and resets the flag.

4. The device of claim 3, wherein the decoder detects the first saturation IN/OUT code and sets the flag, and detects the second saturation IN/OUT code and resets the flag.

5. The device of claim 1, wherein the storage unit temporarily stores the digital data received via the encoder and outputs the digital data via the decoder.

6. The device of claim 1, wherein the calculation unit comprises:
a lens shading correction unit configured to carry out lens shading correction on the digital data and to output the digital data; and
a damage correction unit configured to carry out damage correction on the digital data using the digital data received from the lens shading correction unit and the digital data received from the storage unit via the decoder and to output the digital data.

7. The device of claim 2, further comprising:
a parallel serial conversion unit configured to convert the digital data received from the clip circuit from a parallel input to a serial output or from a serial input to a parallel output.

8. The device of claim 1, further comprising:
a black level addition unit configured to add black level data to the digital data received from the analog digital conversion unit.

9. The device of claim 1, wherein the encoder, the storage unit, the decoder, and the calculation unit are formed in one chip.

10. An information processing circuit comprising:
a storage unit configured to temporarily store digital data received via an encoder and to output the digital data via a decoder; and
a calculation unit configured to calculate the digital data received from the storage unit via the decoder and to output the resultant data,
wherein the encoder encodes the digital data so as to subtract a predetermined level+1 level from data included in the digital data and having a level higher than the predetermined level, and
the decoder decodes the digital data so as to add the predetermined level+1 level to data included in the digital data and having a level resulting from a subtraction of the predetermined level+1 level carried out by the encoder.

11. The circuit of claim 10, further comprising:
a clip circuit configured to fix, to the predetermined level, data which is included in the digital data received from the calculation unit and which has a level equal to or higher than the predetermined level.

12. The circuit of claim 10, wherein the encoder adds a first saturation IN/OUT code to first data included in the digital data and having a level higher than the predetermined level and sets a flag, and the encoder adds a second saturation IN/OUT code to a first pixel included in the digital data and having a level equal to or lower than the predetermined level and resets the flag.

13. The circuit of claim 12, wherein the decoder detects the first saturation IN/OUT code and sets the flag, and detects the second saturation IN/OUT code and resets the flag.

14. The circuit of claim 10, wherein the storage unit temporarily stores the digital data received via the encoder and outputs the digital data via the decoder.

15. The circuit of claim 10, wherein the calculation unit comprises:
a lens shading correction unit configured to carry out lens shading correction on the digital data and to output the digital data; and
a damage correction unit configured to carry out damage correction on the digital data using the digital data received from the lens shading correction unit and the digital data received from the storage unit via the decoder and to output the digital data,
wherein the digital data results from a conversion of a signal charge generated by pixels.

16. The circuit of claim 11, further comprising:
a parallel serial conversion unit configured to convert the digital data received from the clip circuit from a parallel input to a serial output or from a serial input to a parallel output.

17. The circuit of claim 10, further comprising:
a black level addition unit configured to add black level data to the digital data,
wherein the digital data results from a conversion of a signal charge generated by a plurality of pixels.

18. The circuit of claim 10, wherein the encoder, the storage unit, the decoder, and the calculation unit are formed in one chip.
